(19) United States
(12) Patent Application Publication
(10) Pub. No.: US 2011/0196784 A1
(43) Pub. Date: Aug. 11, 2011

(54) SYSTEM AND METHOD FOR INCENTIVIZING AND CONFIRMING THE COMPLETION OF TASKS USING AN ELECTRONIC ESCROW SERVICE

(76) Inventors: Yechiel Newman, New York, NY (US); Matthew Leader, Brooklyn, NY (US)

(21) Appl. No.: 13/023,515

(22) Filed: Feb. 8, 2011

Related U.S. Application Data
(60) Provisional application No. 61/302,888, filed on Feb. 9, 2010.

(51) Int. Cl. G06Q 40/00; G06F 15/16

(52) U.S. Cl. 705/39; 709/229

(57) ABSTRACT

A system and method for incentivizing and confirming the completion of tasks using an electronic escrow service. In one embodiment, Organizer 100 invites Invitee 200 to post escrow online to ensure a meeting occurs between the parties. The meeting is arranged by Server 300. Invitee confirms appearance either via location broadcast or by disclosing a system-generated password to Organizer upon meeting, which Organizer SMS texts to Server. If Invitee's appearance is confirmed, the Server releases Invitee's escrow back to Invitee. If Invitee's appearance is not confirmed, the escrow is forfeited and donated to a recipient charity 500 of Invitee's choosing.

### CROSS-REFERENCE TO RELATED APPLICATIONS

Provisional application No. 61/302,888 filed on Feb. 9, 2010

### FEDERALLY SPONSORED RESEARCH

None

### SEQUENCE LISTING

None

### BACKGROUND

1. Field of Invention

This invention relates to computerized escrow and financial transfer services, specifically to creating and/or using such a service for the purpose of incentivizing the completion of promised personal (as opposed to strictly online or financial) actions and transactions.

2. Prior Art

Opportunity and financial risks exist for the parties to any transaction. If two or more people agree to complete a business transaction, attend a meeting, or exchange accurate information, there is always the risk that one party may fail to follow through on their promise or obligations. This failure can result in significant costs in time and effort (opportunity costs) and money (financial costs) to the non-failing party.

Such risks can be mitigated through the use of third party escrow services. Escrow is the process by which a third party (the “escrowee”) holds a deposit provided by one party to ensure compliance with contract terms by a second party. Upon receiving confirmation that a triggering event has occurred, the escrowee will carry out the terms of the escrow agreement, which usually involves the release or return of goods or funds. Note that an escrow agreement as used herein is any set of terms which direct the escrowee to deal with the security deposit in a specific manner.

Escrow can be used to lessen both financial and opportunity cost risks in business transactions. As an example of lessening financial risks, in a transaction for the sale of goods, a purchaser may be asked to place the full monetary amount of the purchase price in escrow until the escrowee receives confirmation that the goods have been shipped by the seller. This use of escrow eliminates financial risk for the seller by guaranteeing that the full purchase price has been provided before shipment. For the purchaser, financial risk has been eliminated by ensuring that the deposited money will be returned to the purchaser by the escrowee, and thus no loss will be suffered, if the goods are not shipped by the seller as promised.

Escrow may also be used to lower the opportunity costs of a business transaction by remunerating the parties for giving up the opportunity to transact with others. One common example is a non-refundable deposit on real estate purchases. If Bob is buying a house from Sally, Bob will usually be required to put a certain percentage of the purchase price of the house in escrow as a deposit. This deposit incentivizes Sally to withdraw the house from the market while the terms of the deal are finalized and Bob arranges financing. If the parties finalize the contract and Bob secures financing before the trigger date, then the deposit is forwarded to Sally and is subtracted from the purchase price. If the trigger date passes without the fulfillment of the required terms, the escrowee forwards the deposit to Sally as payment for her lost opportunity costs in dealing with Bob.

Historically, such escrow services required the transacting parties to physically deposit cash or goods with a third party escrowee, who personally confirmed the completion of the required trigger events before carrying out the terms of the escrow agreement. However, with the emergence of the Internet and other communication networks, a number of semi-automated escrow systems have been developed to lower the costs and increase the efficiency of financial escrow services.

Most of these inventions utilize the Internet and other communications networks to improve the traditional escrow process for situations in which escrow is currently used, such as the purchase of real estate. For example, U.S. patent application 2002/0087461 entitled “Technique for Electronic Funds Escrow” filed Dec. 28, 2000 by R. Ganesan, et. al. describes a method for transmitting and storing information regarding an escrow transaction electronically over the internet. U.S. Pat. No. 7,127,406 entitled “Method and Apparatus for processing Escrow Transactions”, filed Apr. 11, 2001 by C. Richard Triola, describes a system whereby parties to a real estate transaction may use the Internet to execute and store all the standard documents required to trigger the release of funds for the purchase of real estate.

In other patents, the charging of a security deposit is applied to financial transactions other than real estate. In U.S. Pat. No. 7,415,425 entitled “Systems and Methods Wherein a Security Deposit Facilitates a Transaction in which a Benefit is Applied in Exchange for Performance of a Task” filed Oct. 6, 2000 by Jay S. Walker et. al. describes a network-based system in which a retail customer is incentivized to enter into a secondary financial transaction for goods or services with one or more merchants through the combination of a benefit or subsidy and a security deposit.

What is common to the entire prior art is that it is generally designed for business situations in which the participants are already engaged in a financial transaction. Accordingly, they use solutions that require both parties to be engaged in the purchase and sale of goods or services, and use as a security deposit a reduction or increase in the payments or interests being already transferred between the parties. To our knowledge, no current system is optimized to use an escrowed security deposit to incentivize participants to follow through on promised non-financial activities such as appearing at meetings.

For example, many people now make arrangements to meet each other over the Internet. If one party was required to place a security deposit in escrow in order to confirm the time and place of the meeting, that party would have a greater incentive to show up at the meeting. Similarly, many people are requested to provide data to other parties, the accuracy of which may only be confirmed later. If the party supplying the information was required to provide a security deposit to ensure the accuracy of the data, they would have a greater incentive to do so.

The prior art would require both parties to have systems in place for the transfer of funds between them, would have no way of arranging or confirming a non-financial transaction or task, and would release the security deposit to one of the parties upon default, creating an incentive for that party to cause the other to default in order to gain the security deposit. The present invention addresses these problems by providing an optimized system and method for using a communications network to incentivize the completion of non-financial tasks through the use of security deposits. In addition to incentivizing the completion of the task itself, the present invention reduces the risk of fraud by the secondary party and allows for mobile self-confirmation of task completion in certain circumstances.

### SUMMARY

To alleviate problems inherent in the prior art, the present invention introduces a system and method for creating an escrow service that is optimized to incentivize actions by one or more parties to an event or transaction that is not necessarily monetary. This is accomplished by applying the risk-mitigation capabilities of monetary escrow to 1) the problem of incentivizing in-person meetings and other activities that involve two or more parties who are 2) self-reporting compliance with 3) transaction terms that are not necessarily monetary while 4) minimizing the risk of fraud.

Various embodiments of this invention are possible. People arrange meetings for a variety of purposes (sales, sports, social events, networking, business events, charity events, etc.). Organizers of these events invest time and effort in them, and often would like Invitees to similarly feel invested. At the same time, if they are being requested to put a deposit down to ensure attendance upon meeting, invitees would like to know that the Organizer does not have an incentive to cause the Invitee to default (i.e. miss the meeting) in order to receive the Invitee's security deposit.

One embodiment of the invention allows one person (the Organizer) to incentivize one or more other people (the Invitee(s)) to appear at a meeting in person by requiring the Invitee(s) to place funds in escrow until Invitee's appearance is confirmed. If the Invitee's appearance at the meeting is confirmed then the escrowed funds are returned to the Invitee. If the Invitee fails to appear then the escrowed funds are donated to charity.

In this embodiment, Organizer sets up the meeting using a server over the Internet, sets an amount for the security deposit, and invites Invitee to the event. Invitee enters their credit card or bank information and nominates a third party to receive the escrow as a penalty or donation in the event that Invitee does not appear at the meeting location on time. The system places a hold on the escrow amount in Invitee's account or credit card. If Invitee has a location broadcast-enabled device (such as GPS, cell triangulation, etc.), Invitee confirms appearance by effectuating a location broadcast from the relevant coordinates within the transmission confirmation time window. If Invitee does not have a location broadcast-enabled device, the system issues one party a transaction password. Note that “password” as used herein includes any unique identifier which may be suitable for confirmation purposes, including an alphanumeric string, an image, a tone or sound, a light-based data transmission, and a barcode or other optical machine-readable data mark. Upon meeting the other party, the first party discloses the password to the second party, who transmits the password from their pre-registered mobile device within the transmission confirmation time window. Upon receipt of the password or location confirmation, the server releases the hold on Invitee's account. If the deadline passes without confirmation, the server charges Invitee's account on behalf of the nominated recipient.

Accordingly, several objects and advantages of the invention are evident: to provide a method of using an escrowed security deposit to incentivize personal appearances and other non-monetary transactions; to provide an improved, automated escrow system; to provide a means for self-confirming escrow triggers; to provide a means of mobile and instantaneous deposit and release of escrow funds; to provide a means of raising money for nominated parties; to minimize the incentive for fraud. Still further objects and advantages will become apparent from a study of the following description and accompanying drawings.

### DRAWINGS

FIG. 1 is a flowchart overview of one embodiment of the escrow-based meeting incentive system.

FIG. 1A is an example of a meeting Organizer's data entry page of FIG. 1.

FIG. 1B is an example of a meeting Invitee's data entry page of FIG. 1.

FIG. 1C is an example of the confirmation screens and SMS messages of FIG. 1 prior to the meeting.

FIG. 1D is an example of the SMS messages of FIG. 1 sent to Invitee after the meeting deadline expires.

FIG. 2 is an overview of the embodiment's data entry and organization carried out by the server.

FIG. 3 is a flowchart of the FIG. 1 and FIG. 2 embodiment's transaction decision model.

FIG. 4 is an overview of an alternate embodiment of the invention.

### DETAILED DESCRIPTION

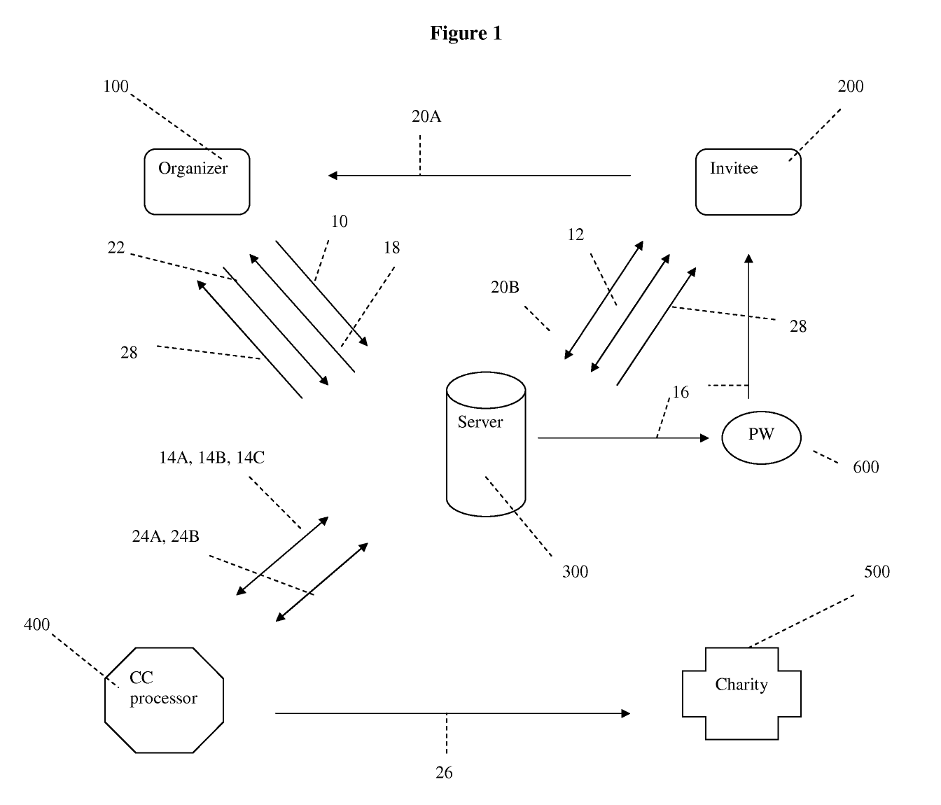

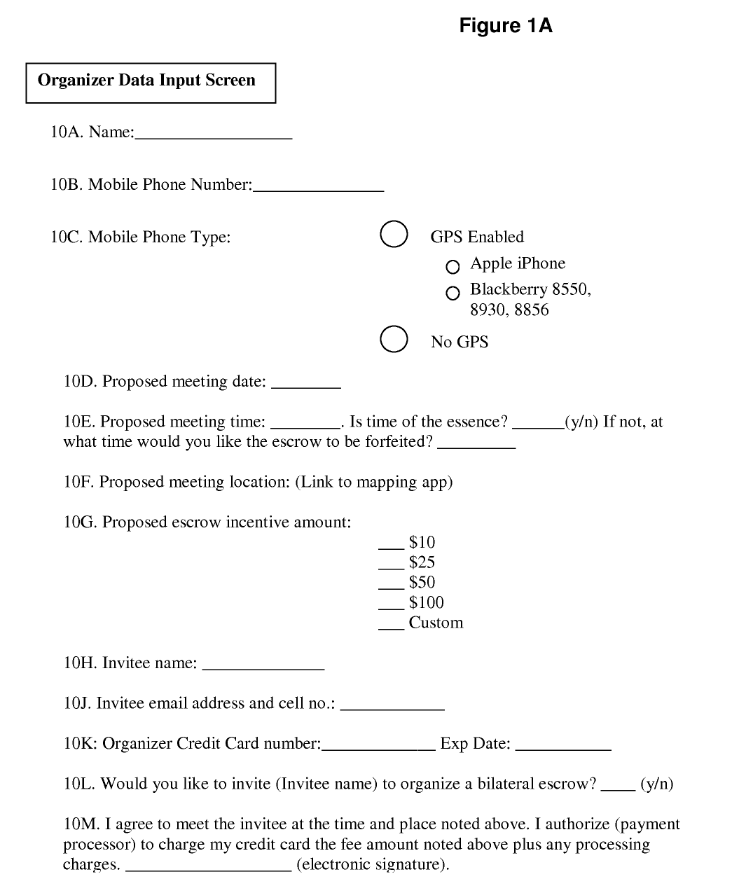

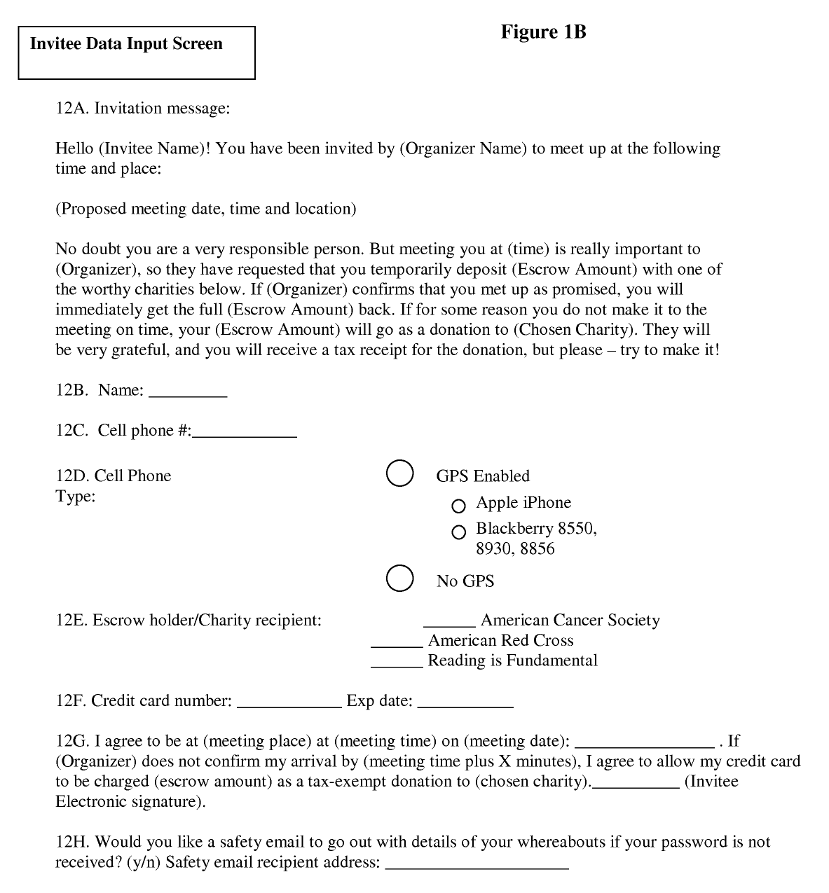

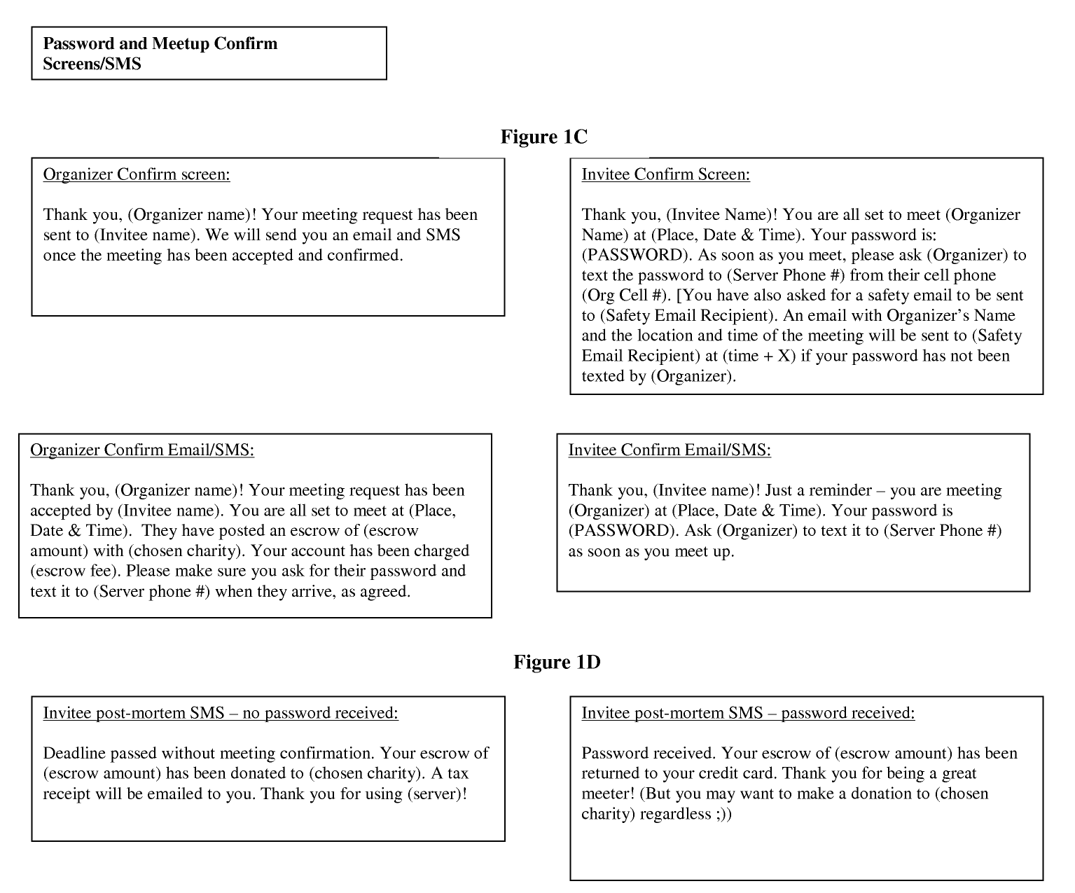

FIG. 1 is a flowchart overview of one embodiment of the invention that incentivizes one or more Invitees 200 to attend one or more meetings set by Organizer 100. Organizer submits data 10 across a communications network to a Server 300.

As detailed in FIG. 1A, the following are representative data inputs that may be entered by Organizer: name 104, mobile device number 10B, cell device type 10C, proposed meeting date 10D, proposed meeting time details 10E, proposed meeting location 10F, escrowed security deposit amount 10G, Invitee name and contact information 10H & 10J and payment details 10K. Note that as used herein, “escrow” and “security deposit” means anything of value which is placed in escrow to incentivize performance. For example, the Invitee may provide the security deposit via a credit card account, a debit card account, a checking account, a mobile banking account and/or an electronic payment protocol. In a preferred embodiment, Organizer may choose 10L whether to offer Invitee the chance to make the incentive bilateral. Organizer completes an electronic contract 10M agreeing to meet Invitee at the stated time and place, and authorizing an account charge for the meeting setup fee. Organizer then sees the “Organizer Confirm Screen” (FIG. 1C).

Returning to FIG. 1, Server 300 sends an invitation to Invitee 200 to enter the data 12 detailed in FIG. 1B. Invitee receives the invitation itself 12A, and may be asked to provide matching data 12B-12D as that provided by Organizer Invitee may also be asked to choose a charity 12E to receive the security deposit in case of default. A “charity” as used herein can be any third party designated to receive the security deposit upon default. Invitee executes an electronic agreement 12G. Invitee may be offered the option to set up a “safety email” 12H. A safety email includes any notification system including email, SMS, recorded telephone message or other similar method that informs a third party of the whereabouts of the sender at a specific time and provides other information as desired.

Returning to FIG. 1, once Organizer and Invitee's account information is entered, Server confirms 14A the validity of the account with bank or credit card processor 400. Once confirmed, server retains the escrow amount by, for example, placing a hold or “auth” 14B on Invitee's account. Server charges Organizer the meeting setup fee 14C. If required, unique transaction password 600 is generated and sent 16 to Invitee and a meeting confirmation 18 is sent to Organizer, potentially via SMS or email (see FIG. 1C). Note that the password may be provided to either party for release to the other, depending on the perceived balance of risk between the parties.

Assuming that the parties meet as intended, Invitee either broadcasts their position via location broadcast 22B or password is disclosed 20A by Invitee to Organizer. Organizer transmits the password, potentially via SMS 22 to Server. Note that the password confirmation may be by any communications device, including a telephone, internet-connected computer, wireless transmission or similar services. Server instructs 24A the account processor to release the hold on the Invitee's account or 24B to charge the Invitee on behalf of the charity 500. The funds are passed 26B to the charity. A final summary of the transaction is sent to both parties 28 (see FIG. 1D).

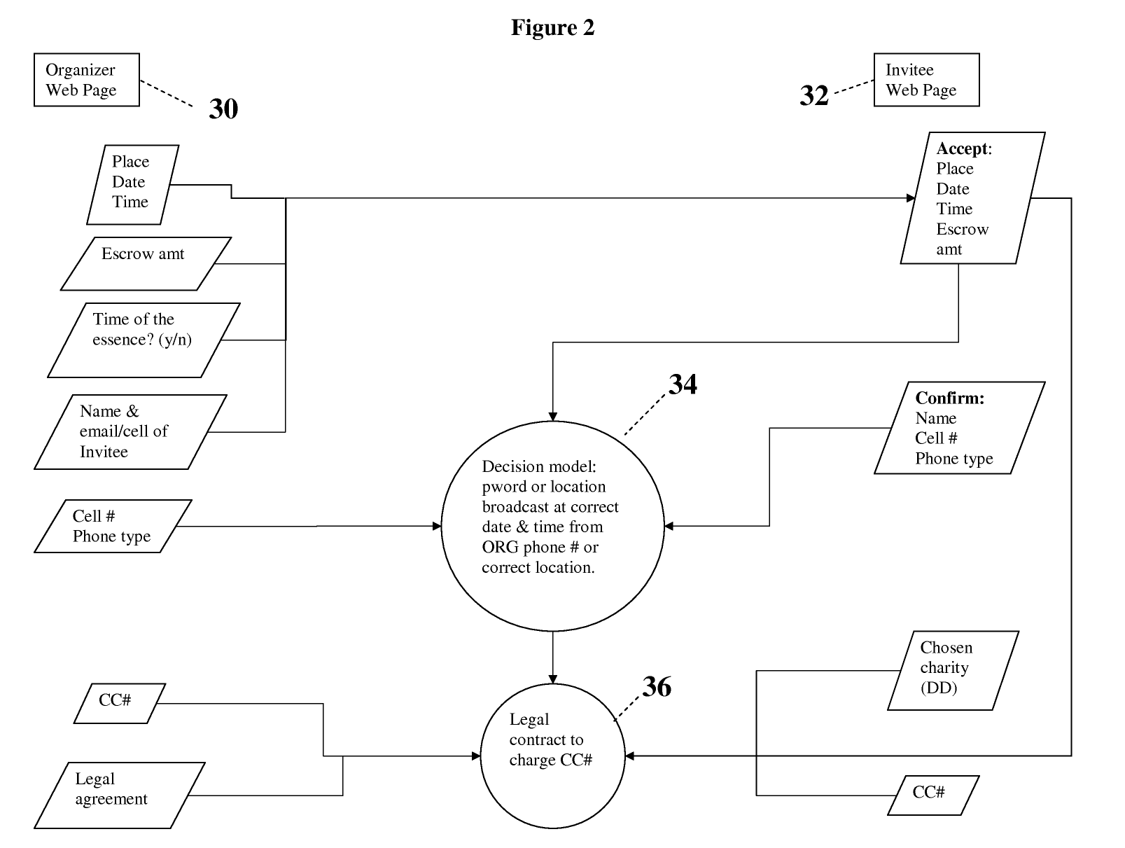

FIG. 2 is a detail of the data organization carried out by Server. Server reviews the data from Organizer input page 30 and Invitee input page 32. Server matches the data inputs to set meeting requirements and build a decision model 34 for escrow release or loss. Information regarding account numbers and meeting and payment agreements are matched 36 to create a legal contract authorizing Server to charge both parties' accounts if necessary.

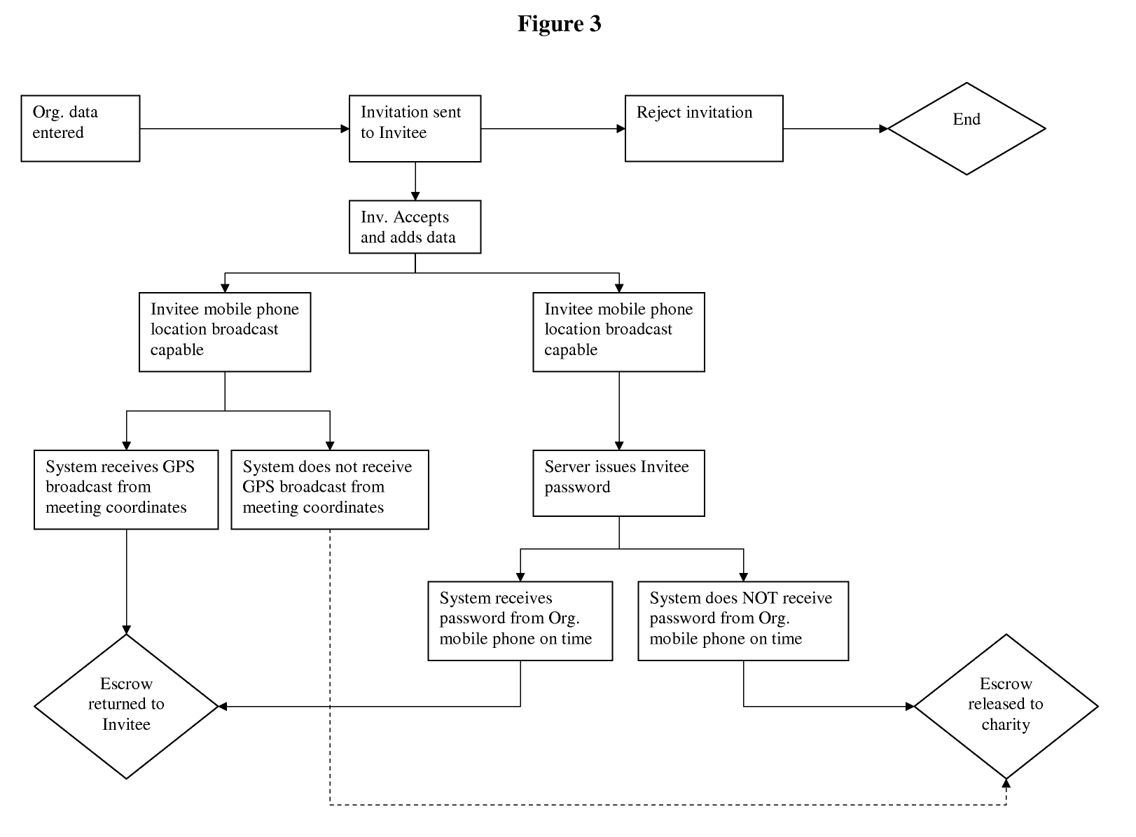

FIG. 3 is an example of a decision model followed by Server in determining whether a meeting and associated release requirement set has been created, and whether to return Invitee's escrow or release it to the nominated charity.

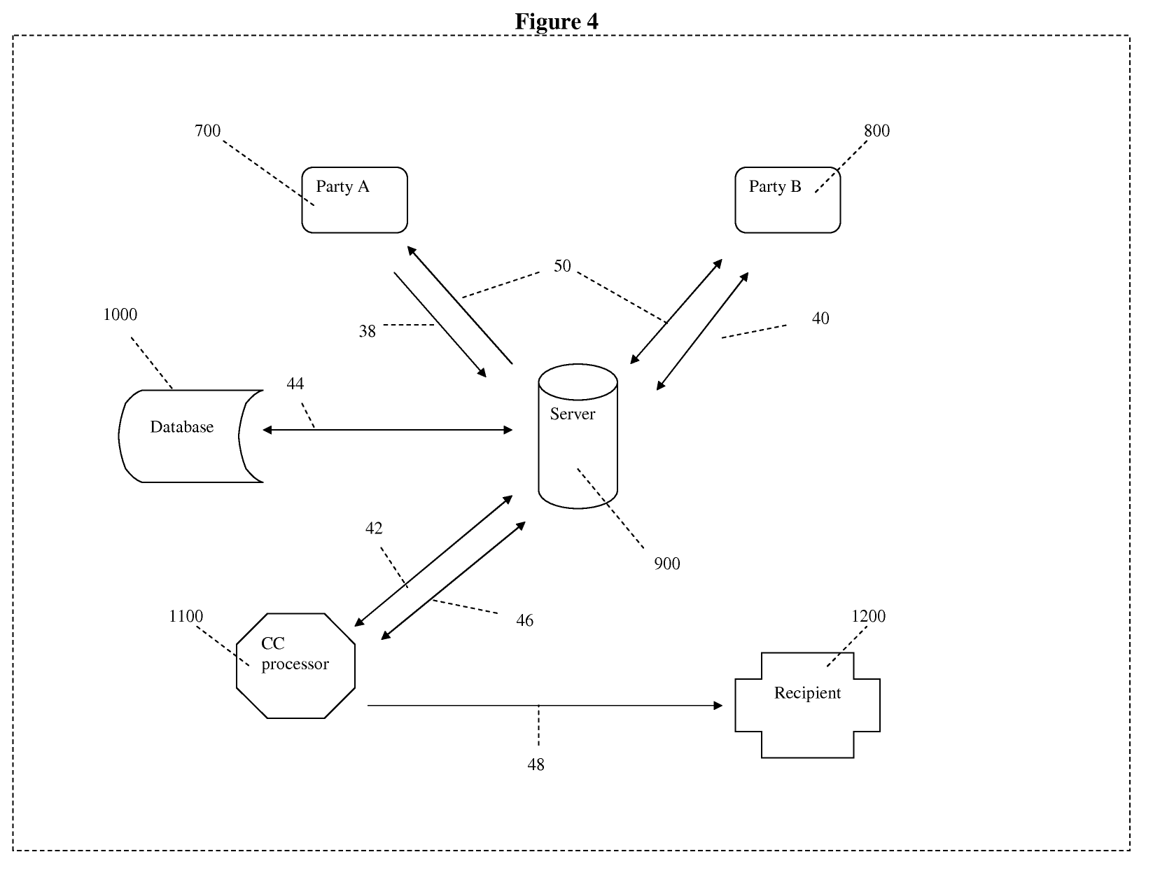

FIG. 4 is an alternate embodiment of the invention optimized for the confirmation of data rather than incentivizing personal meetings.

### Operation

The operation of a preferred embodiment of the system (FIG. 1) begins with Organizer 100 deciding to meet in person with one or more Invitees 200. Organizer begins the process, for example by logging onto a website connected to a Server 300. Organizer registers with the site and provides personal information (see FIG. 1A, 10A-10C). Organizer enters all data relevant to the meeting itself (10D-10F). Organizer may choose an incentive amount 10G that each Invitee will have to place in escrow in order to confirm Invitee's attendance at the meeting. A variety of escrow amounts may be suggested, each with an associated meeting setup fee. Organizer may also choose a custom escrow amount, which could generate a custom setup fee based upon a percentage of the escrow. As a way to encourage Invitee's acceptance and participation, Organizer may choose to give Invitee the opportunity 10L to become the Organizer in a minor transaction, in effect requiring Organizer to similarly post an security deposit to ensure Organizer's appearance at the meeting. Finally, Organizer agrees 10M to meet Invitee if the invitation requirements are accepted and to be legally bound to pay the meeting setup fee. Server confirms the validity of Organizer's account information 14A with an outside entity such as a bank or credit card processor 400.

Server then runs an internal operation and creates a meeting invitation based upon Organizer's inputs and transmits it 12 to Invitee. The internal operation may be stored in a compressed, uncompiled and/or encrypted format. The internal operation furthermore includes program elements that may be necessary, such as an operating system, a database management system and “device drivers” used by the Server to interface with peripheral devices. Appropriate program elements are known to those skilled in the art.

If Invitee agrees to accept the invitation 12A, Invitee may be asked to similarly register with the site and provides personal information 12B-12D. A description of the release trigger will be provided to Invitee. Note that release triggers may be any event or task agreed to by the parties, including appearing at a specified location and time or the confirmation of data's accuracy. Invitee may be given the opportunity to accept or reject the proposed security deposit amount, or to reply with Invitee's own suggested amount. Invitee then chooses 12E a charity to receive the incentive amount in the event that Invitee fails to execute the release trigger. Server confirms the validity of Invitee's account information 14A, and then places a hold or “auth” on Invitee's account 14B. An “auth” is a term of art describing a funds check performed by a credit card processor against a credit card prior charging said card.

Part of the information provided by Invitee is mobile device type 12D. If Invitee's mobile device is location broadcast enabled, Server may set up a decision model (FIG. 2 & FIG. 3) that provides for location broadcast confirmation of Invitee's location. (Because location data is determined by latitude and longitude coordinates, any online mapping application, including those offered by Google or Yahoo Maps, may be used to collect and translate street address data into coordinates when Organizer enters the meeting location 10F.)

If Invitee's mobile device is not location broadcast enabled, Server may generate a random transaction password 600. Server transmits a password to Invitee along with a confirmation of all meeting details. A confirmation of all the meeting details (without the password) may also be transmitted 18 to Organizer (FIG. 1C).

The meeting is now set, and the Invitee has an incentive in the amount of the escrowed security deposit to appear as promised. (If Invitee was offered and chooses to accept the offer make the escrow bilateral, then a matching process is carried out including all steps previously described in which Invitee is Organizer and Organizer is Invitee, creating an incentive for both parties to appear).

If Invitee appears at the meeting location at the correct time, Invitee may confirm their appearance, in this example by using either the location broadcast or the password transfer protocol, as appropriate. In the location broadcast protocol, Invitee simply engages the location broadcast function on their device. Server receives the location broadcast and confirms location and time 20B. In the password protocol, Invitee may disclose 20A the transaction password to Organizer. Organizer provides the password, by SMS or other means 22 to Server from Organizer's registered device or location 10B, confirming the meeting between the parties.

If confirmation is received by Server within the proper timeframe (and from the correct device or coordinates, as appropriate), Server instructs processor to release the hold on Invitee's account 24A. If confirmation is not received, Server instructs processor to charge Invitee's account the full amount of the escrow 24B. The escrow amount is then transferred 26 to Invitee's preferred charity. A summary of the transaction is sent to both parties (see FIG. 1D).

### Additional Embodiments

A variety of additional embodiments to the invention are possible. In a second embodiment, the password is issued to the Organizer rather than the Invitee, shifting the balance of risk between the parties. Such an embodiment is useful in cases in which the Invitee wishes to have control over the actual transmission of the password to the Server, while the Organizer wishes to have a list of all issued passwords in advance of each meeting. In a third embodiment, the incentivized transaction is the accurate transmission of data, rather than a physical meeting between parties. Such an embodiment is beneficial in cases where, for example, Party A requires data immediately, which can only be confirmed later. Example situations include those in which Party A wants to ensure that Party B will make a telephone call at a specific time, or that Party B's car will only have been driven a specified number of miles, or that when Party A and Party B meet, Party B is in fact a 40 year old male. In these embodiments, Party B is requested to provide data to Party A. The data is transmitted to Party A through the server. The server then polls an outside data confirmation source, such as an online database, at a set time in the future. If the information provided is confirmed, the escrow is returned to Party A. If the data is found to be false, the escrow is released to a designated third party.

FIG. 4 is an overview of such a non-appearance based embodiment. Party A 700 sends an information request 38 to Server 900. Server forwards the request 40 to Party B 800. The information request includes a date/time upon which outside validation of the requested information will be possible. If Party B accepts the request, Party B enters the information into the Server and provides payment account information. Server then checks the payment data 42 with an outside account manager or credit card processor 1000. The processor places a hold for the agreed upon amount on Party B's account. Server runs an internal operation to determine the most appropriate Database 1000 to validate the provided information. Once the appropriate date/time has passed, Server queries 44 the appropriate Database to see if the release trigger or triggers have occurred. If the information is validated, Server instructs 46 credit card processor to release the hold on Party B's account. If the information is found to be incorrect, Server instructs credit card processor to charge Party B's account the amount of the escrow and pass it 48 to the recipient party 1200. Both Parties are then informed of the result of the database check, and Party B is given a receipt for their donation, if appropriate 50.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

We claim:

1. A method of incentivizing the completion of a task organized between two or more parties, comprising:
i) arranging for a meeting or other task to be organized between two or more parties;
ii) arranging for one or more of the parties to place a security deposit in escrow;
iii) confirming compliance or non-compliance with the terms of the escrow agreement;
iv) arranging for the transfer of the security deposit to one or more parties.

2. The method of claim 1, wherein said meeting or other task comprises any activity other than the immediate purchase of goods or services or other immediate transfer of funds between the parties.

3. The method of claim 1, wherein said arranging for said meeting comprises:
i) providing one or more parties with the ability to send an invitation to complete a task to one or more other parties;
ii) providing the inviting party or parties with the ability to propose an amount for a security deposit;
iii) providing the invited party or parties with the ability to accept such invitation;
iv) providing the invited party with the ability to accept or reject the proposed security deposit;
v) providing one or more of the parties with the ability to confirm completion of such task.

4. The method of claim 3, wherein said arranging further comprises the mobile transmission and acceptance of the individual steps required for such invitations.

5. The method of claim 3, wherein said ability to send an invitation further comprises the ability to create binding contract and escrow terms.

6. The method of claim 3, wherein said ability to accept or reject the proposed security deposit further comprises the ability for the invitee to respond with a counterproposal.

7. The method of claim 3, wherein the said ability to confirm completion of said task further comprises issuing a password to one party.

8. The method of claim 3, wherein the said ability to confirm completion of said task further comprises:
i) providing the server with details regarding the capabilities of invitee's mobile device; and
ii) determining the appropriate password type.

9. The method of claim 1, wherein the said ability to arrange for the placement of a security deposit in escrow further comprises:
i) confirming the acceptance of the escrow agreement;
ii) collecting details regarding payment options;
iii) allowing the nomination of a third party recipient for the security deposit in case of default;
iv) removing the amount of the security deposit from the control of the provider of the security deposit; and
v) confirming the identity and requirements of the release trigger of the escrow agreement.

10. The method of claim 9, wherein the collection of the details regarding payment options comprises data provided by at least one of (i) the invitee, (ii) the invitee's bank or financial institution, (iii) the invitee's credit card provider, (iv) other provider's acting on invitee's behalf.

11. The method of claim 1, wherein confirming compliance or non-compliance with the terms of the escrow agreement is comprised of comparing data received by the server with the execution of the release triggers agreed to by the parties.

12. The method of claim 11, where the confirmation of said compliance is provided by the parties sending data to a server.

13. The method of claim 11, where the confirmation of said compliance is automatically generated and sent to the server.

14. The method of claim 11, wherein said data is comprised of confirmation of the physical location of one or more parties.

15. The method of claim 14, wherein said confirmation of the physical location of at least one party is confirmed by the transmission of said party's map coordinates.

16. The method of claim 14, wherein said confirmation of the physical location of at least one party is confirmed by the transmission of a password to one or more additional parties.

17. The method of claim 12, wherein said data is transmitted to a server via a communications network.

18. The method of claim 1, wherein the arranging for the transfer of the security deposit to one or more parties further comprises:
comparing the data received by the server with the agreed-upon release triggers;
determining the party to receive the security deposit; and
instructing the holder of the security deposit to forward the said security deposit to a specific party.

19. The method of claim 18, wherein the transfer of the security deposit further comprises confirming successful completion of the release triggers and returning said deposit to the original provider of the deposit.

20. The method of claim 18, wherein the transfer of the security deposit de-incentivizes fraud on the part of the organizer of the meeting by transferring said deposit to a third party upon the failure of the invitee to successfully execute the agreed-upon release triggers.

21. A method of providing additional security for parties attending meetings comprising:
arranging a meeting between two or more parties;
arranging for data to be sent to a server upon the execution of a predetermined trigger event; and
arranging for said server to send a third party a predetermined notification upon the receipt of such data.

22. The method of claim 21, wherein said trigger event is the expiration of a specified time period.

23. The method of claim 21, wherein said trigger is the failure to transmit a password.

24. The method of claim 21, wherein said notification further comprises the location of the sending party.

24. The method of claim 24, wherein said location is determined automatically.

25. A medium for incentivizing the completion of a task organized between two or more parties, comprising:
a processor; and
a storage device coupled to said processor and storing instructions adapted to be executed by said processor to:
arrange for a meeting or other task to be organized between two or more parties;
arrange for one or more of the parties to place a security deposit in escrow;
confirm compliance or non-compliance with the terms of the escrow agreement;
arrange for the transfer of the security deposit to one or more parties.
